(19) United States
(12) Patent Application Publication
(10) Pub. No.: US 2014/0293037 A1
(43) Pub. Date: Oct. 2, 2014

(54) OPTICAL MICROSCOPE AND METHOD FOR EXAMINING A MICROSCOPIC SAMPLE

(71) Applicant: CARL ZEISS MICROSCOPY GMBH, Jena (DE)

(72) Inventors: Ingo Kleppe, Jena (DE); Yauheni Novikau, Jena (DE); Christoph Nieten, Jena (DE); Ralf Netz, Jena (DE)

(73) Assignee: CARL ZEISS MICROSCOPY GMBH, Jena (DE)

(21) Appl. No.: 14/227,322

(22) Filed: Mar. 27, 2014

(30) Foreign Application Priority Data
Mar. 28, 2013 (DE) 10 2013 005 563.6

(51) Int. Cl. G02B 21/00

(52) U.S. Cl. CPC G02B 21/0032
USPC 348/80; 359/385

(57) ABSTRACT

An optical microscope includes a first mask that has transmission regions that are separated from one another for the simultaneous generation of a plurality of illumination light beams from illumination light, for example, a first scanning device for generating a scanning motion of the illumination light beams and a sample holder. The optical microscope also includes a second mask with transmission regions separated from one another, which transmission regions are smaller than the transmission regions of the first mask in order to clip the illumination light beams, such that, through the scanning motion of the first scanning device, each of the illumination light beams can be successively passed onto different transmission regions of the second mask, and a second scanning device is provided for generating a scanning motion between the clipped illumination light beams and the sample holder. A method for examining a microscopic sample is also provided.

### CROSS-REFERENCE TO RELATED APPLICATIONS

The present patent application claims priority from German Application No. 10 2013 005 563.6, filed Mar. 28, 2013, which is incorporated herein by reference in its entirety.

### BACKGROUND OF THE INVENTION

1. Field of the Invention

The invention relates to an optical microscope in which masks with transmission regions are used to achieve a high degree of resolution.

2. Description of related art including information disclosed under 37 CFR §§1.97 and 1.98

A microscopic sample may be any object that can be examined using an optical microscope.

A basic goal is to be able to examine a sample at the highest resolution possible. Various methods and optical microscopes are known with which a higher degree of resolution can be achieved than in conventional wide-field microscopy. The known methods and optical microscopes, however, have various disadvantages. Thus, only a small portion of the available amount of light is often used. As a result, the required measurement time increases or the achievable image quality decreases. Also, the equipment expense may be disproportionately high. Using other methods, a very high degree of intensity of the illumination light must be available.

Microscopy using, for example, structured illumination (structured illumination microscopy=SIM) to increase resolution is known. In this case the sample is irradiated with structured illumination light. This light is generated using a grid image. A plurality of images are recorded using various grid alignments and periods, and are then compiled into one high-resolution image. This method has disadvantages, however, when used with thicker samples, for example those thicker than 30 μm. This is particularly because of the undesired detection of unfocused light. There is also the disadvantage that much time is required because of the relatively large number of image captures required.

Furthermore, laser-scanning microscopes (LSM) for generating high-resolution images are known. In these, a point of light or illumination spot is generated in the sample plane. Sample light coming from said sample plane then passes through a diaphragm or a pinhole before it arrives at the detector. Unfocused light is largely blocked by the small size of the pinhole. Thus, confocality is achieved that is better than that achieved with a microscope with structured illumination. A decisive disadvantage of known laser-scanning microscopes, however, is their poor signal-to-noise ratio. This is due to the fact that, in comparison to wide-field equipment, each pixel of a detector is only very briefly illuminated. The exposure time per pixel may be up to seven orders of magnitude smaller than with a wide-field recording. In practice, the reduction of the pinhole leads to a smaller amount of detectable light, and therefore to no improved resolution, or with only slightly better resolution. For this reason, one must often work with a particularly high degree of light intensity. Finally, it is also disadvantageous that the scan speed is relatively low, so that an image capture takes a relatively long time.

Certain improvements are achieved using a generic optical microscope and a generic method. The generic optical microscope comprises a first mask that features separate transmission regions for simultaneous generation of a plurality of illumination light beams of illumination light, a first scanning device for generating a scanning motion of the illumination light beams, and a sample holder for securing a sample.

In the generic method of examining a microscopic sample, illumination light is first emitted. Then, a plurality of illumination light beams are simultaneously generated from the illumination light through light-transmission regions of a first mask, wherein the light-transmission regions are separated from one another. The scanning motion of the illumination light beams is established by first scanning means.

Such a method is known from U.S. Pat. No. 5,428,475 A.

Since a plurality of illumination light beams that come together separately are used simultaneously, a plurality of sample regions separate from one another may be advantageously examined simultaneously. Thus, the time required for image capture decreases.

Any device that can generate a plurality of separate illumination light beams from an impinging light beam, i.e. the illumination light, may be understood to be the first mask. For example, the mask may be a pinhole disk. The apertures thereof constitute the above-mentioned light-transmission regions. Since the illumination light is passed to a plurality of apertures of the pinhole disk simultaneously, a plurality of illumination light beams may be generated.

The first scanning devices may be configured to rotate the pinhole disk, for example. The position change of the apertures of the pinhole disk constitutes a scanning motion of the illumination light beams.

In general, the first scanning devices may be configured in any manner as long as they can be used to set a distribution of the illumination light beams behind the first mask in a variable manner.

A method, by means of which measurement resolution may be improved using a Laser Scanning Microscope, is based on the article “Super-resolution in confocal imaging” by Colin Sheppard et al., which appeared in Optik 80, No. 2, 53 (1988). A detector with local resolution of better than one Airy is used in that context. After image capture, data are sorted and calculated from which an image with increased resolution may be generated. This method is therefore also identified as accumulation of displaced sub-Airy detector values. More detailed descriptions are provided in DE 10 2010 049 627 A1, and in the introduction of DE 10 2012 023 024.

A generic optical microscope in which this method is used is described in EP 2 520 965 A1. A plurality of sample images are recorded, between which the illumination spots in the sample plane are displaced by a distance that is smaller than 1 Airy.

An Airy is defined as the first zero points of a diffraction-limited illumination spot. It is thus a dimension of a diffraction disk within an image plane that refers back to one point in the sample plane. The dimension may be defined as the distance between the first zeros of the diffraction disk, which is also described as an Airy disk. The size of the Airy thus depends on the particular optical microscope and the light wavelength. The Airy disk can have a radius of 0.61λ/NA, wherein λ is the light wavelength, and NA is the numerical aperture of the measurement system.

Using successively-generated illumination spots that are displaced toward one another in the sub-Airy range, one sample image each is recorded using a generic optical microscope. With illumination displacements in the sub-Airy range, the position of the illumination spot within the sample plane determines which detector element primarily receives light from the sample from a fixed sample position. For this reason the successively-recorded measurement data from one specific detector element are assigned to various sample points. This is also known as resorting of the recorded image data. Each of the detector elements must be smaller than 1 Airy in order to be able to detect displacements in the sub-Airy range.

For a displacement of the illumination spots in the sub-Airy range, a scanning mirror or tiltable glass plate is inserted between the pinhole disk and the sample plane according to EP 2 520 965 A1. A continuous scanning motion of the illumination light would indeed be generated by the rotation of the pinhole disk and the subsequent scanning device. However, only a single sample region that is as point-like as possible is to be illuminated for each image capture, not a larger linear region. For this purpose, the illumination light is directed onto the pinhole disk in a flash- or strobe-like manner. A camera chip with which sample light is recorded must be read out very often in order to prevent measurements from successively following illumination flashes from interfering with one another.

This increases the time required according to EP 2 520 965 A1 to generate an image with high resolution.

Also, the use of a pinhole disk described in EP 2 520 965 A1 leads to no insignificant light losses. Therefore the sample regions to be examined at a specific time should be as small as possible. The size of the illuminated sample regions can indeed be reduced if the size of the transmission regions, meaning the size of the pinholes of the pinhole disk, is reduced. This, however, reduces the demonstrable amount of sample light. Therefore, the resolution improvement is clearly limited.

### BRIEF SUMMARY OF THE INVENTION

One object of the invention can be considered that of presenting an optical microscope as well as a method to examine a microscopic sample by means of which images of particularly high resolution may be generated with low time requirement.

The problem is solved in the case of the optical microscope of the type described above, in that provision according to the invention is made that a second mask is provided with light-transmission regions, which are separated from one another, that are smaller than the light-transmission regions of the first mask to clip the illumination light beams, that each of the illumination light beams is successively directed to each of a plurality of transmission regions of the second mask by means of the scanning motion of the first scanning means, and that second scanning means are provided to generate a scanning motion between the clipped illumination light beams and the sample holder.

In the method of the type mentioned above, provision according to the invention is made that the illumination light beams are clipped by transmission regions of a second mask, for which purpose the transmission regions of the second mask are smaller than the transmission regions of the first mask; that, by the scanning motion of the first scanning means, each of the illumination light beams is successively directed onto each of a plurality of transmission regions of the second mask; and that a scanning motion is generated between the clipped illumination light beams by means of second scanning means.

A significant consideration of the invention is the fact that the first scanning means do not generate a continuous scanning motion of the illumination light beams in the sample plane. Rather, a scanning motion is provided by means of the second mask. As long as an illumination light beam strikes the same transmission region of the second mask during this scanning motion of the first scanning means, this scanning motion does not lead to a change in position of the clipped illumination light beams in the sample plane as long as the second scanning means does not perform a scanning motion. Thus, during the scanning motion of the first scanning means, a stationary illumination in the sample plane is achieved for a short time. After this time, the illumination light beams no longer strike the transmission regions because of the scanning motion of the first scanning means, and are blocked by the second mask on their way to the sample plane. After an additional time period, the illumination light beams strike other transmission regions of the second mask. By illuminating other transmission regions of the second mask other regions at the sample plane are also illuminated.

It is thus possible for the first scanning means to be able to perform a continuous scanning motion of the illumination light beams. Since this scanning motion is performed via the second mask, illumination points are generated in the sample plane, rather than somewhat larger, undesired illumination lines.

It is not necessary to send the illumination light beams toward the sample in brief flashes or pulses. In contrast, this is required in conventional optical microscopes and methods such as according to EP 2 520 965 A1. No image capture can occur there while the first scanning means perform a scanning motion of the illumination light beams.

A particularly important advantage of the invention is due to the fact that each of the illumination light beams coming from one of the transmission regions of the first mask strikes successively onto a plurality of transmission regions of the second mask, and not merely onto one transmission region of the second mask. Thus, the number of successively-generated illumination spots per unit of time is increased.

For example, in EP 2 520 965 A1, at a first point in time, a specific number of pinholes of the pinhole disk, meaning at transmission regions of the first mask, is irradiated with an illumination pulse. At a later point in time at which the pinhole disk has rotated, an illumination pulse is again emitted toward a specific number of pinholes. Between these two time points, no illumination spots are generated at the sample plane.

In contrast, according to the invention, a plurality of transmission regions of the second mask are successively illuminated during that same time interval, whereby a plurality of illumination spots are generated successively in the sample plane. This reduces the measurement time required.

It is also significant that a camera chip, with which the sample light is recorded, does not have to be read every time the pattern of illumination spots within the sample plane is changed. If an illumination light beam from the first mask is scanned successively across a plurality of transmission regions of the second mask, then illumination spots are created in the sample plane as a result that are spatially separated from one another to such an extent that sample light coming from them does not overlap, or only barely overlaps. Thus, the camera chip can integrate sample light into successively-generated illumination spots without having to be read in the meantime. The result is that the camera chip may be read less often, which in turn saves time.

Increase in resolution is advantageously achieved laterally and axially, i.e., not only within the sample plane, but also in the depth direction.

In general, the transmission regions of the first and second masks may be defined in that they transmit illumination light toward the sample plane in contrast to the other regions of these masks. For example, light may be transmitted through the transmission regions while it is blocked from other regions of the associated mask, and particularly absorbed, scattered, or reflected. Alternatively, the transmission regions may also reflect light while not reflecting light from other regions of the associated mask, or reflect it in another direction and thus not toward the sample plane. The transmission regions of the first mask can be configured to be the same as those of the second mask, or to be different.

Basically, illumination light that has already been split into a plurality of partial beams may also be passed to the first mask. In this case, the transmission regions of the first mask generate the described illumination light beams from the plurality of partial beams. Preferably, however, exactly one expanded illumination light beam is passed to the mask.

The first and second scanning means may in turn be either identical or different. The only important fact is that a spatial distribution of illumination light beams can be adjusted relative to the sample. Generally, the first and/or second scanning means can be configured for the purpose of changing a position of the first and/or second mask, for example using piezo actuators, or, however, to deflect light, that is, the illumination or sample light, between this mask and the sample plane in an adjustable manner.

It is also possible to provide a sample-displacement device. Using this, the sample holder can be displaced relative to the illumination light by a motor. This can also provide a scanning motion. This scanning motion occurs relative to the clipped illumination light beams that emerge from the second mask. Therefore, the sample-displacement device may constitute a second scanning means.

The sample holder may be any type of holder, in particular a microscope stage or a holder for a microscope stage, with which a sample or a sample container may be secured. The sample-displacement device or unit may therefore also comprise a motor to displace the microscope stage.

The first mask can, for example, have a first pinhole disk. The transmission regions are formed in this case as apertures. In principle, transparent elements may also be used instead of apertures, for example parallel-faced plates or collimating lenses. High scan speeds are achieved when the first scanning means have adjustment means for changing the position of the pinhole disk. The pinhole disk is preferably rotated by means of the adjustment means. The transmission regions may then be arranged in one or two spirals on the pinhole disk. Such a disk is also known as a Nipkow disk.

A conventional optical microscope may advantageously be easily be retrofitted with a Nipkow disk, for example. For this, in addition to control equipment, only the second mask and second scanning means need be added.

In order to pass as much illumination light as possible through the apertures of the pinhole disk, the first mask in front of the first pinhole disk can comprise a micro-lens disk. The micro-lenses of the micro-lens disk also constitute transmission regions that generate a plurality of illumination light beams from incident illumination light. So that each micro-lens is always directed toward one of the apertures, the micro-lens disk and the pinhole disk are preferably rigidly coupled to each other and rotated together.

Instead of rotation of the pinhole disk and a micro-lens disk that may be provided, the first scanning means can also be configured in principle to perform any other displacement of these elements.

Also, the first scanning means can comprise a scanning mirror or other deflecting means with which illumination light beams coming from the first mask may be variably deflected. In this case, the first mask may also be fixed.

The second mask and the transmission regions thereof may be configured as described in the context of the first mask. The transmission regions of the second mask are distinguished from those of the first mask in size and density, meaning their separation distance. Each of the transmission regions of the first mask is preferably equal to, or greater than, one Airy disk. It is especially preferred if each of the transmission regions of the second mask is smaller than one Airy disk, and particularly if it has a diameter of between 0.2 and 0.5 Airy, and preferably between 0.3 and 0.4 Airy. The clipped illumination light beams thus generate illumination spots in the sample plane whose diameter is only slightly larger than 1 Airy, and thus approach the smallest illumination spot that may in principle be generated using such an optical microscope.

A separation between adjacent transmission regions of the second mask is preferably smaller than the separation between adjacent transmission regions of the first mask, and preferably at most half as large. If the two masks are displaced with respect to each other, the illumination light beams are emitted successively from the first mask to each of a plurality of transmission regions of the second mask. Thus, a sample may be scanned, i.e., sampled, more quickly.

In order to prevent unnecessary loss of sample light, it is particularly preferred that sample light is directable to the first mask without being clipped by the second mask. The relatively small transmission regions of the second mask may thus lead to small illumination spots in the sample plane without blocking sample light on its path to a detection device.

A point in the sample plane is not imaged onto an infinitely-small point in an intermediate-image plane, but to the size of an Airy disk. If each of the transmission regions of the first mask has the size of an Airy disk, then unnecessary blocking of the sample light is advantageously avoided. A desired blocking of non-focused sample light is achieved if these transmission regions are no larger, or are only slightly larger, than one Airy disk.

In principle, the second mask may be disposed in the light path of the sample light or in a different light path. In the first case, the second mask is preferably configured such that, outside its transmission areas, it either blocks light or passes light between the first mask and the sample plane depending on wavelength, in order to clip incident illumination light beams, and to pass incident sample light toward the first mask. This version is suitable when the sample light is fluorescent or phosphorescent light, and is therefore of a different wavelength than the illumination light. Outside its transmission region, the second mask can have a threshold wavelength between transmission and reflection that lies between the wavelengths of the illumination light and the sample light.

Alternatively, beam splitters can prevent sample light from reaching the second mask and being blocked by it. Thus, a first color splitter and a second color splitter may be provided as the beam splitter and can be disposed such that they pass illumination light beams from the first color splitter to the second color splitter via the second mask, and that they do not pass sample light from the second color splitter to the first color splitter via the second mask. The two color splitters may again have a threshold wavelength between transmission and reflection that lies between the wavelengths of the illumination light and the sample light.

If the second scanning means move the second mask, then the illumination field of view as provided by the first mask and the first scanning means is not changed. If, on the other hand, the second scanning means deflect the light between the second mask and the sample plane in a variable manner, then the illumination field of view is slightly moved within the sample plane, for example in a plurality of steps up to 1.5 Airy. In a preferred embodiment such motion is compensated, by means of which more complex control systems and evaluations can be avoided. For this, the second scanning means are configured such that on the one hand light is deflected between the first and the second mask in an adjustable manner, and on the other hand also deflect light between the second mask and the sample plane in an adjustable manner. Thus, the second scanning means first displace the illumination field of view that is generated by the first mask and the first scanning device, and then ensure an additional, compensated displacement. For this, the second scanning means can comprise two reflective or refractive surfaces, for example, that are rotated at the same angle. Illumination light beams then pass from the first mirror surface via the second mask to the second mirror surface.

A holder for releasable securing the second mask is advantageously provided so that a user of an optical microscope has to make only minor changes in order to perform other microscopy procedures. The second mask may then be removed by hand in order to enable the capture of a wide-field image. In addition, the second mask may be replaced by one or more grids in order to produce structured illumination light.

A magazine may be provided instead of such a holder. With this, it is optional whether the second mask, a grid, or no optical element whatsoever is placed into the light path.

It is useful for sample light coming from a sample at the sample plane to be recorded by a detection device, for example a camera device such as a CCD or CMOS camera. In a preferred version of the method, the camera device integrates the received signals while illumination light continuously irradiates the first mask and the first scanning means generate a scanning motion of the illumination light beams. During the integration period of the camera device the scanning motion of the first scanning device nonetheless does not lead to undesired large illumination lines in the sample plane because of the second mask.

The time required to examine a sample can be reduced if integration of the received signals from the camera device is only discontinued, and the image thus captured is read out, when each of the illumination light beams has been passed successively onto a plurality of transmission regions of the second mask. As a result the quantity of read-out procedures of the camera device is advantageously reduced. A scanning motion of the second scanning device preferably occurs between integration periods of the camera device, and not, however, while the clipped illumination light beams are passed onto the sample and the detector device integrates signals received.

Particularly in this case the second scanning device can be controllable to perform a scanning motion between two image captures of the camera device in which the clipped illumination light beams in the sample plane are displaced by a distance that is smaller than 1 Airy, and preferably smaller than ¼Airy. The read-out time of the camera device may be used in this case for the scanning motion of the second scanning device.

The scanning motion of the second scanning means can also occur so slowly during the integration period of the camera device that the clipped illumination light beams are displaced in the sample plane during the integration period by a distance that is smaller than 1 Airy, and preferably smaller than ¼Airy. Such a slight displacement has little effect on the achievable accuracy.

For the subsequent calculation of the high-resolution image, the performed displacement of ¼Airy, for example, must be known. Depending on the scanning means the displacement performed can be subject, however, to an unknown degree of accuracy. In this case, the displacement actually performed may be calculated based on the recorded images. For this, the positions of the sample illumination spots are compared with those in a second image. The displacement of sample illumination spots between these two images provides the desired displacement of, for example, ¼Airy.

Typically, the separation of adjacent transmission regions of the first mask is from 5 to 10 Airy. The transmission regions of the second mask, on the other hand, lie closer together, and are 1.5 to 4 Airy apart, for example. For that reason not just a few illumination spots are generated at a separation of 5 to 10 Airy during a camera integration period, but rather a larger number of illumination spots that are 1.5 to 4 Airy apart from one another.

In comparison to the sole use of a first mask with transmission regions at a separation of 6 Airy from one another, a second mask with transmission regions at a separation of 2 Airy allows generation of a larger number of illumination spots per image capture. This quantity is three times as large along the lateral direction, and thus nine times as large overall. Thus the number of images required is reduced by a factor of 9.

This number may be reduced even further. Provision can be made that initially the first scanning motion is performed during an integration period of the detection device, and each of the illumination light beams is passed to a plurality of transmission regions of the second mask. The illumination light is then switched off or blocked before reaching the sample. Also, the setting for the second scanning device is adjusted. Then, illumination light is again passed to the sample again, with the first scanning motion still or again performed. Provision can be made that this process occurs once or several times successively upon adjustment of the second scanning device. Only then are the integrated signals of the detection device read. This allows advantageous reduction to the required read-out processes. It is important in this context that the illumination spots successively generated during an integration period at the sample plane have a mutual separation of at least 1 Airy.

This distribution is particularly preferred when the separation distances between the transmission regions of the second mask are relatively large, for example greater than or equal to 3 Airy. In this case, one or even two illumination spots can be generated successively between the illumination spots, which are generated by adjacent transmission regions of the second mask at a specific setting of the second scanning means.

### BRIEF DESCRIPTION OF THE SEVERAL VIEWS OF THE DRAWINGS

In the following, additional advantages and features of the invention will be described with reference to the accompanying schematic figures, which show:

FIG. 1 shows an embodiment of an optical microscope according to the invention;

FIG. 2 shows an enlarged section of the optical microscope from FIG. 1;

FIG. 3 shows a graph of the spatial intensity distribution of the illumination light;

FIG. 4 shows a graph of the spatial intensity distribution of the sample light;

FIG. 5 shows an enlarged section of components of the optical microscope according to FIG. 1;

FIG. 6 shows a second embodiment of an optical microscope according to the invention;

FIG. 7 shows a third embodiment of an optical microscope according to the invention;

FIG. 8 shows a fourth embodiment of an optical microscope according to the invention.

Identical components and components with identical function are generally provided with identical reference numerals.

### DETAILED DESCRIPTION OF THE INVENTION

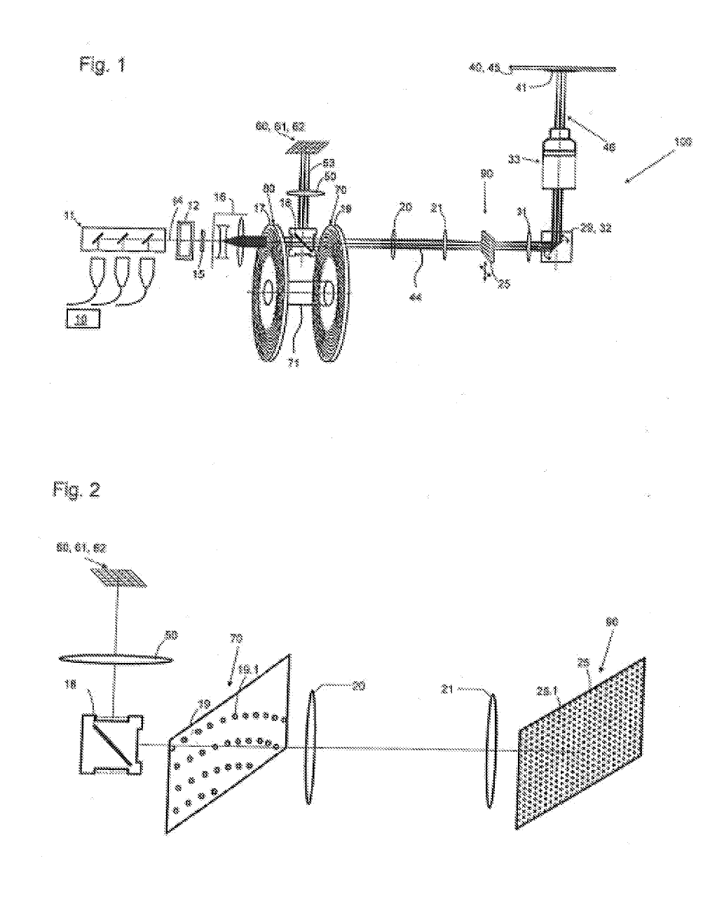

FIG. 1 shows schematically a first embodiment of an optical microscope 100 based on the invention. A first and a second mask 19, 25 are provided as essential components, as well as first and second scanning means 71, 29.

Initially, illumination light 14 is emitted from a light source 10. In the illustrated example the light source 10 comprises a plurality of laser modules whose light paths are combined into a common light path via optical fibers and a stepped mirror 11. The illumination light 14 passes through an acoustic-optical tunable filter (AOTF) 12, a lambda/4 plate 15, and a telescope for the beam expander 16.

The illumination light 14 then strikes a first mask, which in this case is formed by a micro-lens disk 17 and a pinhole disk 19. A plurality of focusing lenses are arranged on the micro-lens disk 17 in one or a plurality of spirals. The pinhole disk 19 has apertures that are also arranged in one or more spirals. The micro-lens disk 17 and the pinhole disk 19 are rigidly coupled to one another, and are configured such that each micro-lens focuses an illumination light beam onto an associated aperture.

Since the illumination light 14 is passed onto a plurality of adjacent micro-lenses simultaneously, each of the illuminated micro-lenses generates an illumination light beam 44. The illumination light beams 44 are again clipped depending on the size of the apertures in the pinhole disk 19. The micro-lenses and the apertures of the pinhole disk 19 thus constitute transmission regions that can generate a plurality of illumination light beams 44.

Basically, the micro-lens disk 17 may be omitted. Its focusing effect can, however, advantageously have the effect that a larger portion of the illumination light 14 passes through the apertures of the pinhole disk 19.

In order to be able to illuminate various sample regions successively, the micro-lens disks 17 and the pinhole disk 19 are rotated about a common axis by drive means 71. These drive means 71 constitute first scanning means 71, which generate a scanning motion of the illumination light beams 44.

The illumination light beams 44 are passed via optical devices 20 and 21 to a second mask 25. Said second mask comprises a plurality of transmission regions that are separated from one another and through which illumination light beams 44 may be transmitted in the direction of a sample plane 40. Outside the transmission areas, the mask 25 blocks impinging light beams 44. The size of the transmission regions of the second mask 25 is selected such that all illumination light beams 44 are clipped, meaning their cross-sectional areas are reduced. The interaction of the first and the second masks 19, 25 will be described further below in greater detail.

The illumination light beams 46 clipped by the second mask 25 are passed via optical devices 31 onto a scanner 29. Said scanner is located in the pupil plane, and can variably adjust the deflection direction of the clipped illumination light beams 46. Thus, the scanner 29, which may be referred to as second scanning means 29, can perform a scanning motion of the clipped illumination light beams 46 within the sample plane 40. The scanner 29 can be, for example, a galvanometer scanner or MEMS (micro-electro-mechanical scanner).

Instead of the scanner 29, a fixed mirror 32 can be used. A scanning motion can then be provided, characterized in that a sample holder 45 can be displaceable relative to the clipped illumination light beams 46 by a sample-displacement unit.

Also, adjusting means for re-positioning the second mask 25 can be provided as second scanning means. The adjusting means can displace the mask 25, for example, toward the two illustrated double arrows.

The clipped illumination light beams 46 are then focused at the sample plane 40 using an objective lens 33. In this sample plane, a sample 41 can be placed, which also can be displaced by means of a sample-displacement unit 45.

The clipped illumination light beams 46 generate illumination spots in the sample plane 40 that are separated from one another. Due to the small size of the transmission regions of the second mask 25, the illumination spots are advantageously particularly small. The smallest possible illumination spots that may be generated using an optical microscope have the size of an Airy disk. If illumination light travels from an infinitely-small point to an intermediate image plane, the illumination light cannot be imaged on an infinitely-small point in the sample plane 40. Instead the image formed is diffraction limited. Thus, a point of an intermediate image plane is imaged on an expanded area in the sample plane 40. This expanded region can be referred to as an Airy disk.

The pinhole disk 19 and the second mask 25 are each disposed in an intermediate image plane 70, 90. The transmission regions of the second mask 25 are each smaller than one Airy disk. For example, they can have a diameter between 0.3 and 0.5 Airy. Thus, illumination spots are generated in the sample plane 40 that advantageously have dimensions of only 1 Airy. A high degree of measurement resolution can be achieved by means of these small illumination spots. In this context it is, however, also relevant that as great a portion as possible of the emitted sample light 53 is detected.

Sample light 53 is understood to be the light emitted from the sample 41, which may be fluorescent or phosphorescent light, for example. Said light is then passed through the objective lens 33, the scanner 29, or the mirror 32 and the optics 31.

In the embodiment according to FIG. 1 the sample light 53 then passes through the second mask 25. If the second mask 25 were to act on illumination light beams 44 and sample light 53 in the same manner, a larger portion of the sample light 53 would be lost. This would be disadvantageous to the signal-to-noise ratio or an achievable degree of resolution. It is therefore important that the second mask 25 does not clip the sample light 53. This will be described further below in greater detail.

Sample light 53 is passed further via the optical devices 21 and 20 to the pinhole disk 19. Portions of the sample light 53 are blocked by the apertures and the blocking regions of the pinhole disk 19 surrounding them. A point in the sample plane 40 with the size of 1 Airy disk is imaged to an expanded region in the intermediate image plane 70 in which the pinhole disk 19 is located. In order to make it possible to pass all the sample light coming from a single point in the sample plane 40 the apertures in the pinhole disk 19 should not be smaller than 1 Airy.

On the other hand, sample light originating from another area of the sample plane 40, or not originating from the sample plane 40, must be blocked to the greatest degree possible. The apertures of the pinhole disk 19 should therefore not be unnecessarily large. Therefore, the apertures preferably have a diameter of 1 Airy, or in any case a diameter between 0.8 and 1.2 Airy.

After passing through the pinhole disk 19, the sample light 53 impinges on a beam splitter 18. This may be, for example, a color splitter whose threshold wavelength from reflection to transmission lies between the wavelengths of the illumination light and the sample light. Thus, the color splitter 18 does not pass sample light 53 to the micro-lens disk 17, but rather via an optical device to a detection device 60. This device is located in an image plane 62, and comprises a plurality of detector elements 61, which may be constituted, for example, by a 2D camera chip.

Each of the detector elements 61 is smaller than an Airy disk, and preferably has a diameter of less than 0.5 Airy. Each sample point is thus imaged onto a plurality of detector elements 61. Nonetheless, this small size of the detector elements 61 can achieve a resolution increase, as described in detail above.

The interaction of the first and the second mask 19, 25 will now be explained with reference to FIG. 2. Said figure shows an enlarged view from FIG. 1. Only a section of the first mask 19 or pinhole disk 19 is shown. Said mask comprises a plurality of apertures 10.1 that are spirally arranged.

The second mask 25 likewise comprises a plurality of transparent regions 25.1 as transmission regions. It will be appreciated that the transmission regions 25.1 of the second mask 25 are smaller than those of the pinhole disk 19, and also possess higher density. Each illumination light beam is successively passed to various transmission regions 25.1 of the second mask 25 by means of the rotation of the pinhole disk 19. Thus, each illumination light beam successively generates illumination spots in the sample plane whose positions are determined by the positions of the transmission regions of the second mask 25. The illumination pattern thus generated at the sample plane may be referred to as static or quasi-static.

Each of the detector elements 61 can integrate received signals while a scanning motion is performed across the second mask 25 with the illumination light beams from the pinhole disk 19. The same integration interval of a detection device 60 may preferably be used in order to successively generate illumination spots with various transmission regions of the second mask 25 in the sample plane. The integrated signal of the detector element 61 is read only after this integration interval. The number of read-out procedures required may thus be reduced.

This configuration offers advantages over the implementation described in EP 2 520 965 A1. There, a pinhole disk that corresponds to the pinhole disk 19 is rotated. However, no second mask 25 is used. Only using said second mask, however, quasi-static illumination spots that are at a particularly small separation from one another are generated successively at the sample plane.

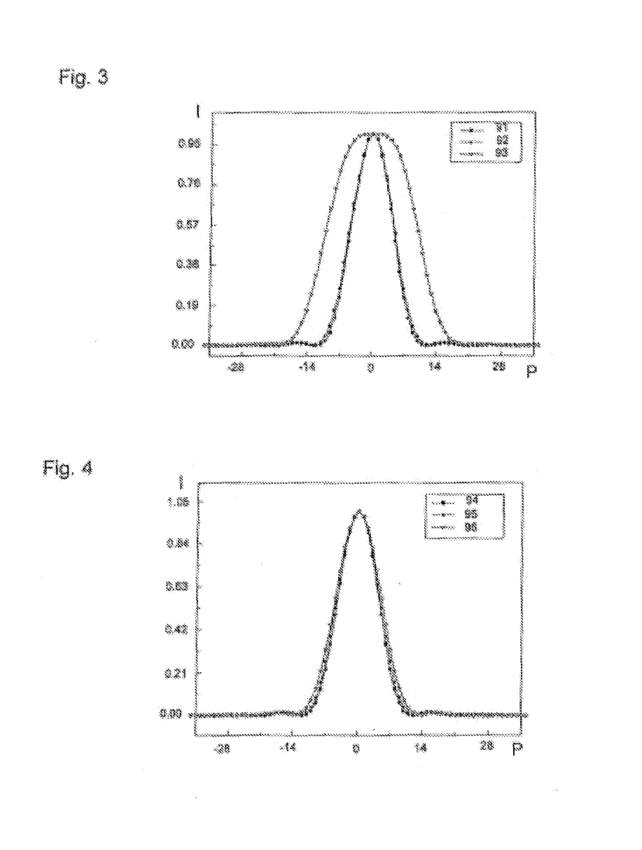

The illumination spots also possess particularly small dimensions because of the small transmission regions 25.1 of the second mask 25. This will be described in greater detail with reference to FIG. 3. In said figure light intensity I is shown using arbitrary units with respect to a position P in the sample plane. A curve 91 represents the point-spread function (PSF) of the optical microscope, meaning the composite point-image function. This gives the intensity distribution of the smallest possible illumination spot that can be generated by the microscope in the sample plane if a point light source were present at an intermediate plane.

The curve 92 represents the intensity of an illumination spot in the sample plane if a transmission region 25.1 of the second mask 25 with a diameter of 0.4 Airy is used.

In curve 93, in contrast to curve 92, a transmission region 25.1 with a diameter of 1.0 Airy is used.

It can be seen in FIG. 3 that the illumination spot of the curve 93 is considerably larger than the PSF of curve 91. In contrast, the illumination spot of the curve 92 is only slightly larger than the PSF indicated by curve 91. In order to be able to generate the smallest possible illumination spots in the sample plane, the dimensions of the transmission regions 25.1 are therefore preferably between 0.3 and 0.5 Airy, and particularly preferably 0.4 Airy.

Sample light may be emitted from an illuminated point in the sample plane. This point is formed in the intermediate planes 70 and 90 in a region whose diameter is at least 1 Airy. For this reason, only those illumination light beams are clipped by the mask 25 whose transmission regions 25.1 are smaller than 1 Airy, and not the sample light.

FIG. 4 in turn shows the intensity I of light in arbitrary units with respect to a position P in the sample plane 62.

The curve 94 represents the PSF for the sample light. Thus, the intensity distribution of the smallest possible light spot is represented that can be generated on the detector by sample light. If the apertures 19.1 of the pinhole disk 19 have dimensions of maximum 1 Airy, then light spots may basically be generated on the detection device whose dimensions correspond to those of PSF 94. Here, however, one must take into account that the sample light at the edges of the apertures 19.1 is subject to diffraction effects. After passing through the apertures 19.1, the sample light is therefore slightly expanded. In order to send as much of the sample light as possible along to the detection device, the optical device 50 shown in FIG. 2, which is positioned between the pinhole disk 19 and the detection device 60, must have a greater numerical aperture than the optics 20 that is traversed by the sample light before the pinhole disk 19. For example, the numerical aperture of the optical device 50 may be 1.3 times as large as the numerical aperture of the optical device 20. In this case, a light spot according to curve 95 from FIG. 4 may be generated at the detection device. This curve is largely identical to PSF 94.

Curve 96, in contrast, shows the smallest possible light spot at the detection device if the numerical aperture of the optical device 50 is equal to the numerical aperture of the optical device 20. It is recognizable that the curve 96 is undesirably wider than curve 94.

If the sample light were to be clipped by the small transmission regions 25.1 of the second mask 25, then the width of a potentially-generated light spot at the detection device would still largely correspond to the widths of curves 95 and 96. The intensity of the illumination spot would be less, however, than that of the curves 95 and 96.

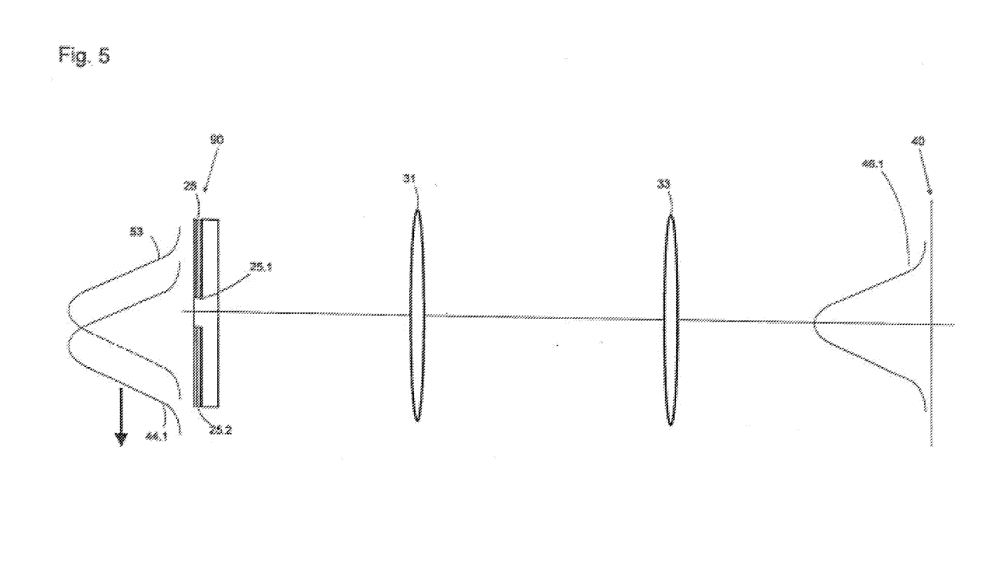

Therefore, the second mask 25 must not clip the sample light. One embodiment example in which this is achieved is described using FIG. 5. Said figure shows schematically a section of the second mask and the optical device 31 and the objective lens 33.

The mask 25 comprises a transparent support that is coated with a dichroitic coating system 25.2. The transmission regions 25.1 are formed by regions of the support that are not provided with the coating system 25.2. The coating system 25.2 blocks illumination light but allows sample light to pass.

An illumination light beam 44.1 that strikes a transmission region 25.1 off-center is thus filtered out. The illumination light beam thus clipped generates an illumination spot 46.1 in the sample plane that is aligned with the transmission region 25.1.

Finally, an intensity distribution of sample light 53 is shown that is emitted from a centrally-illuminated point in the sample plane 40 and is not blocked by the coated regions 25.2.

Such a mask 25 may be used in the embodiment according to FIG. 1. For this, however, diffraction effects experienced by sample light at the edges between the transmission regions 25.1 and the coated regions 25.2 can be disadvantageous.

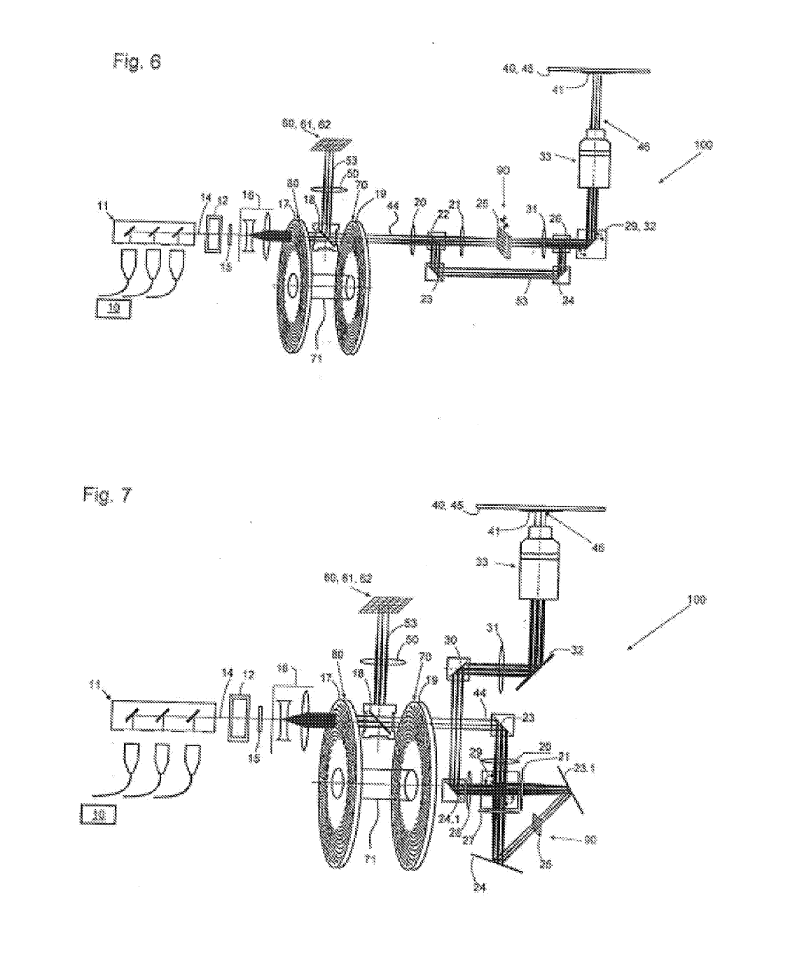

These effects can be avoided in the case of the embodiment according to FIG. 6. In contrast to the embodiment of FIG. 1, the sample light 53 here does not pass through the second mask 25. For this, beam splitters 22, 26 are placed both upstream and downstream of the second mask 25. The beam splitters 22, 26 may be color splitters, for example, via which illumination light beams 44 are passed through the second mask 25, and sample light 53 is passed via another light path. This other light path is formed by mirrors 23 and 24.

In this case, the mask 25 does not have to be formed using a complex coating system. Instead, a light-blocking metal layer might be used on a glass substrate.

FIG. 7 shows schematically an additional embodiment of an optical microscope 100 according to the invention. Said embodiment differs from the embodiments according to FIGS. 1 and 6 particularly in the type of second scanning means 29.

The second scanning means 29 here comprises two mirror surfaces that are rotatable to generate a scanning motion. The two mirror surfaces are moved together through identical angles, and in particular can form the front and rear surface of a body. This is also referred to as descanning

Illumination light beams 44 coming from the pinhole disk 19 are first passed via a mirror 23 and an optical device 20 onto the first mirror surface of the second scanning means 29. From these, said illumination light beams are deflected in a selective manner and passed to the second mask 25 via an optical device 21 and a mirror 23.1. The second mask 25 here can be fixed. The illumination light beams 46 clipped by the second mask 25 are passed onto the second mirror surface of the second scanning device 29 via a mirror 24 and optical device 27. The deflection at the second mirror surface exactly compensates for the deflection at the first mirror surface. The illumination field of view, and thereby the field of view of the detection device 60, is therefore independent of the scanning motion of the second scanning means 29. This means that, if the illumination light beams were not clipped by the second mask 25, their spatial distribution after the second mirror surface would be independent of the scanning motion of the second scanning means 29. Because of the clipping due to the second mask 25, the scanning motion of the second scanning means 29 has the effect of making the cross-sectional area of the illumination light beams 44 clipped by the second mask 25 adjustable.

From the second mirror the clipped illumination light beams 44 are then passed to the sample plane 40 via an optical device 28, a mirror 24.1, a mirror 30, optics 31, a mirror 32, and an objective lens 33.

Sample light 53 is passed back along this path, and in particular also passes via the second mirror surface of the second scanning means 29, the second mask 25, and the first mirror surface of the second scanning means 29 to the pinhole disk 19.

Since the sample light 53 is passed via the described descanning to the detection device 60, the section of the sample plane from which the detection device 60 may receive sample light 53 is advantageously independent of the setting of the second scanning means 29. In other words, the detection PSF is independent of the setting of the second scanning means 29.

Generally, a high-resolution image can also be calculated, as well, when the detection PSF is dependent on the setting of the second scanning means 29. It is only necessary that the relative positions of the excitation PSF, the detection PSF, and the sample be known at any time.

The second mask 25 here may be configured as described according to FIG. 5. Thus, sample light 53 is barely blocked by the second mask 25.

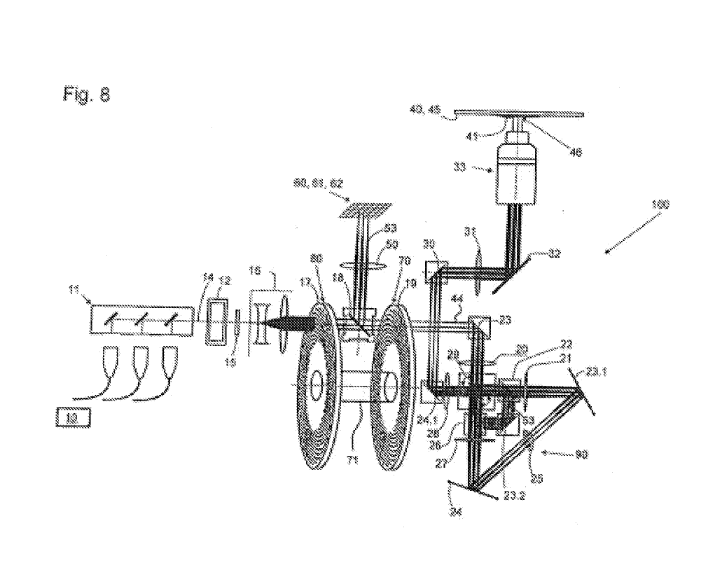

The second mask 25, however, can also be configured such that it affects both the illumination and sample light. In this case, the sample light 53 preferably does not pass via the second mask 25. FIG. 8 shows such an embodiment of an optical microscope 100 according to the invention. In contrast to FIG. 7, a first color splitter 22 is inserted in this case between the first mirror surface of the second scanning means 29 and the second mask 25, and a second color splitter 26 is added between the second mask 25 and the second mirror surface of the second scanning means 29. Thus, sample light 53 is passed over a separate light path via a mirror 23.2, and does not strike the second mask 25.

In the embodiment of the figures the first mask and the first scanning means are always formed by a rotating pinhole disk. The pinhole disk may also be linearly displaceable to provide a scanning motion. Also, another mask may be used instead of the pinhole disk. In this case, the transmission regions may be formed as mirror surfaces or through refracting regions, for example. A micro-mirror array can in particular be used. Furthermore, the first mask can also be fixed. In this case, the first scanning means are configured for the purpose of variably deflecting illumination light beams and sample light between the first mask and the sample plane, for example by means of a rotatable mirror.

Likewise, the second mask 25 may also be implemented differently than described according to FIG. 5. In particular, the second mask can also be configured in a manner as described in the case of the first mask. For this, the two masks and their scanning means can have the same structure or structures that are different.

An exemplary procedure for generating a high-resolution image using an optical microscope 100 is described in the following.

Illumination light is passed to the sample 41 via the pinhole disk 19 and the second mask 25 to the sample 41. The second scanning means 29 initially perform no scanning motion. The pinhole disk 19 is continuously rotated, however. By means of this rotation the illumination light beams 44 emitted by the pinhole disk 19 are initially passed via certain transmission regions of the second mask 25 to the sample 41 and, at a later time, passed to the sample 41 via different transmission regions of the second mask 25. Since the second mask 25 is motionless in this case, the illumination spots generated on the sample 41 in this manner are also stationary.

Each detector element 61 of the camera 60 may therefore continuously integrate received signals during this procedure. This integration is concluded only when the illumination light beams have each been passed from the pinhole disk 19 via a plurality of transmission regions of the second mask 25 to the sample 41.

Then, the received signals are read out from the detector elements 61. During this time, the second scanning means 29 are displaced. The step size of this displacement is so small that the illumination spots generated in the sample plane 40 are displaced by less than 1 Airy, and preferably less than 0.5 Airy. Thereupon the second scanning means 29 are again held stationary, and an additional image capture is performed in the previously-described manner.

A plurality of images are captured in this manner. The number of captured images can be determined by the illumination spot separation and the scanning step width. The illumination spot separation in this case is the distance between two successive illumination spots generatable in the sample plane, which can be generated by adjacent transmission regions of the second mask. The scanning step size in this case indicates by what distance a specific illumination spot is displaced by the second scanning means in the sample plane between two image captures. The number of images to be captured can then be specified as the square of the ratio of the illumination spot to the scan threshold width. The square takes the scanning in two dimensions into account.

Thereafter the images are compiled into a high-resolution image. For this, the resorting of the recorded signals is taken into account, as was explained initially in the context of prior art.

The necessity to resort the received signals can be avoided if an additional scanning motion can be performed. The additional scanning motion is a relative motion between the sample light and the detection device, and is performed simultaneously and depending on the second scanning motion of the second scanning means. For example, the detection device may be displaced, or a scanning mirror can be located in front of the detection device. It is important in this case that the additional scanning motion of the sample light over the detection device is opposite in direction, and is preferably equal in amount to the scanning motion with which the second scanning means guide the clipped illumination light beams across the sample plane.

As a result of the described features of the optical microscope according to the invention, the quantity of images to be captured is relatively small, thus saving time. The illumination spots in the sample plane are also very small due to the dimensions of the transmission regions of the second mask. At the same time, unnecessary blockage by the second mask 25 of portions of the sample light to be detected can be avoided. Since a relatively large amount of illumination light can be passed to the sample plane, and a relatively large amount of sample light reaches the detection device, an image with good signal-to-noise ratio can be captured in a short time.

### REFERENCE-SIGN LIST

10 Light source
11 Stepped mirror with partially-transparent mirrors or color splitters
12 Acousto-optical variable filter (AOTF)
14 Illumination light
15 Lambda/4 glass slide
16 Telescope for beam expansion
17 Micro-lens disk
18,22, 26 Color splitter or beam splitter
19 First mask or pinhole disc
19.1 Transmission region or pinhole of the first mask 19
23, 24 Mirrors
23.1, 23.2, 24.1 Mirrors
20, 21, 27, 28, 31 Optics
29 Second scanning means
25 Second mask or sub-Airy aperture mask
25.1 Transmission area or sub-Airy aperture of the second mask 25
25.2 Dichroic coating system
32 Mirror
33 Objective lens
40 Sample plane
41 Sample
44 Illumination light beams
44.1 Illumination spot in front of the second mask
45 Sample holder, in particular with sample-displacement unit
46 Illumination light beams that were clipped by the second mask
46.1 Illumination spot in the sample plane, created by a clipped illumination light beam 46
50 Optics
53 Sample light
53.1 Sample light spot
60 Detection device, for example camera with 2D chip, in particular with a plurality of sub-Airy detector elements
61 Detector element or pixel
62 Detection or image plane
70, 90 Intermediate image plane
71 First scanning means
91 PSF (point-spread function) of the illumination light
92 Intensity distribution of an illumination spot in a transmission region of the second mask with a diameter of 0.4 Airy
93 Intensity distribution of an illumination spot in a transmission region of the second mask with a diameter of 1.0 Airy
94 PSF (point-spread function) of the sample light
95 Intensity distribution of a sample light spot on the detection device
96 Intensity distribution of a sample light spot on the detection device, using optics with a numerical aperture other than the one used in the case of the intensity distribution 95
100 Optical microscope

1. An optical microscope comprising:
a first mask (19) having transmission regions (19.1) separated from one another for simultaneously generating a plurality of illumination light beams (44) from illumination light (14),
first scanning means (71) for generating a scanning motion of the illumination light beams (44),
a sample holder (45) to hold a sample (41),
a second mask (25) having transmission regions (25.1) separated from one another and smaller than the transmission regions (19.1) of the first mask for clipping the illumination light beams (44), wherein each of the illumination light beams (44) is passible successively to different transmission regions (25.1) of the second mask (25) by means of the scanning motion of the first scanning means (71), and
second scanning means (29) for generating a scanning motion between the clipped illumination light beams (44) and the sample holder (45).

2. The optical microscope according to claim 1, wherein:
the first mask (19) comprises a first pinhole disk (19) in which the transmission regions (19.1) are formed by apertures (19.1), and
the first scanning means (71) comprise adjustment means for changing the position of the pinhole disk (19).

3. The optical microscope according to claim 1, wherein:
each of the transmission regions (19.1) of the first mask (19) is at least as large as an Airy disk and
each of the transmission regions (25.1) of the second mask (25) is smaller than an Airy disk.

4. The optical microscope according to claim 1, wherein:
the separation between adjacent transmission regions (25.1) of the second mask (25) is smaller than the separation between neighboring transmission regions (19.1) of the first mask (19).

5. The optical microscope according to claim 1, wherein:
the second mask (25) is configured to make the sample light (53) passible to the first mask (19) without being clipped by the second mask (25).

6. The optical microscope according to claim 5, wherein:
the second mask (25) blocks light outside its transmission regions (25.1) depending on wavelength.

7. The optical microscope according to claim 5, wherein:
the second mask (25) passes light between the first mask (19) and the sample plane (40) in order to clip incident illumination light beams (44) and to pass incident sample light (53) unclipped in the direction of the first mask (19).

8. The optical microscope according to claim 5, further comprising a first color splitter (22) and a second color splitter (26) arranged to pass illumination light beams (44) from the first color splitter (22) to the second color splitter (26) via the second mask (25) without passing sample light (53) from the second color splitter (26) to the first color splitter (22) via the second mask (25).

9. The optical microscope according to claim 1, wherein:
the second scanning means (29) are configured for one of changing the position of the second mask (25) and variably deflecting light between the second mask (25) and the sample plane (40).

10. The optical microscope according to claim 1, wherein:
the second scanning means (29) are configured to variably deflect light (44, 53) between the first and the second mask (19, 25), and also to variably deflect light between the second mask (25) and the sample plane (40).

11. The optical microscope according to claim 1, further comprising a holder for releasably holding the second mask (25).

12. A method for examination of a microscopic sample (41), using a microscope having a first mask (19) having a plurality of transmission regions (19.1) separated from one another, first scanning means (71), a second mask (25) having a plurality of transmission regions (25.1) separated from one another and smaller than the transmission regions (19.1) of the first mask, and second scanning means (29), the method comprising the steps of:
emitting an illumination light (14),
simultaneously generating a plurality of illumination light beams (44) from the illumination light (14) when the illumination light (14) is directed onto the transmission regions (19.1) of the first mask (19),
using the first scanning means (71) to generate a scanning motion of the illumination light beams (44),
clipping the illumination light beams (44) with the transmission regions (25.1) of the second mask (25),
successively passing each of the illumination light beams (44) to the plurality of transmission regions (25.1) of the second mask (25) by means of the scanning motion generated by the first scanning means (71), and
using the second scanner means (29) to generate a scanning motion between the clipped illumination light beams (46) and the sample (41).

13. The method according to claim 12, wherein the microscope further includes a camera device (60), the method comprising the further steps of:
receiving and capturing sample light (53) coming from the sample (41) using the camera device (60),
using the camera device (60) to integrate the received signals while continuously irradiating the first mask (19) with the illumination light (14), and generating a scanning motion of the illumination light beams (44) using the first scanning means (71).

14. The method according to claim 13, further comprising
discontinuing the integration of the received signals of the camera device (60), and reading out the image thus captured, only after each of the illumination light beams (44) has been successively passed onto the plurality of transmission regions (25.1) of the second mask (25).

15. The method according to claim 13, wherein:
a scanning motion of the second scanning means (29) takes place between integration intervals of the camera device (60), but not during a time when clipped illumination light beams (46) are passed onto the sample (41) and the camera device (60) integrates the received signals.

16. The method according to claim 13, wherein:
the scanning motion of the second scanning means (29) takes place during integration intervals of the camera device (60) so slowly that the clipped illumination light beams (46) are displaced in the sample plane (40) during the integration time by a distance that is smaller than 1 Airy.

17. The method according to claim 13, wherein:
displacing the clipped illumination light beams (46) in the sample plane (40) by a distance smaller than 1 Airy by using the second scanning means (29) to perform a scanning motion between two image captures of the camera device (60).
